(19) United States
(12) Patent Application Publication
(10) Pub. No.: US 2002/0048232 A1
(43) Pub. Date: Apr. 25, 2002

(54) Magnetic position device

(75) Inventor: Chii-How Chang, Taoyuan Hsien (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Delta Electronics, Inc., Taoyuan Hsien (TW)

(21) Appl. No.: 09/855,003

(22) Filed: May 14, 2001

(30) Foreign Application Priority Data
Oct. 24, 2000 (TW) 89218480

(51) Int. Cl. G11B 7/095

(52) U.S. Cl. 369/44.22

(57) ABSTRACT

A magnetic position device for using in a driver is provided. The magnetic position device includes a movable element having a first yoke assembly, and a fixed element adjacent to the movable element for generating a magnetic field to control the movable element to be moved toward a predetermined position.

### FIELD OF THE INVENTION

The present invention relates to a magnetic position device, and more particularly to a magnetic position device for using in a driver having a more precise position.

### BACKGROUND OF THE INVENTION

Generally, data storage media for accessing and recording the data are supported by drivers. The magnetic storage devices, for example, FDD (floppy disk drive) or HDD (hard disk drive), have drivers for magnetic read/write heads. The optical storage devices, for example, Compact Disc (CD), Video CD (VCD) and Digital Video Disk (DVD), have corresponding drivers for optical read/write heads. In addition, Magneto Optical (MO) or Mini Disc (MD) has corresponding drivers for read/write heads. The drivers are used for precisely directing the read/write heads to the working positions.

The position device of the conventional drivers is implemented by using the characteristic of magnetism. FIGS. 1 to 4 are schematic views showing the conventional magnetic position devices for being used in the optical lens driver for an optical read/write head. Based on the structure of the movable element V of the magnetic position device for the optical lens (O.L.) driver, the magnetic position devices are divided into two types as follows.

a) moving coils: the movable element V has a focusing coil F1 and perpendicular tracking coils T1, T2, T3 and T4 thereon as shown in FIGS. 1 to 3.

b) moving magnets: the movable element V has permanent magnets M1 and M2 thereon as shown in FIG. 4.

However, the operation theories applied in the drivers are similar.

The magnetic field is generated by the permanent magnets M1 and M2 and the fixed yokes Y1, Y2 and Y3. When electric current passes through the focusing coils F1 and F2 or the tracking coils T1, T2, T3 and T4, another variable magnetic field is generated owing to electromagnetic induction, and then the relative displacement between the coils and the magnets are generated. The variable relative displacement is regulated by the electric current.

The conventional drivers have several drawbacks. For the moving coils type drivers, the magnetic force is enhanced by applying additional number of the coils wound on the movable element V. Moreover, the additional number of coils results in the heavier movable element V so that the sensitivity of the drivers is decreased. Furthermore, the movable element V for carrying the optical lens O.L. and the coils wound thereon should be produced in advance in the fabricating process. The fabricating process is complicated, and the coils are wounded on the movable element V with difficulty. It is more complicated that the coils are wound in advance, and then fixed to the movable element V. For example, the wound coils mounted on the movable element V in advance is more difficult to accomplish, as shown in FIG. 3.

For the moving magnets type drivers, the permanent magnets M1 and M2 are connected with the movable element V shown in FIG. 4. However, the magnets are much heavier than the coils, so that the sensitivity and the precision of the driver are reduced due to the heavy weight.

It is therefore tried by the applicant to deal with the above situation encountered in the prior art.

### SUMMARY OF THE INVENTION

It is therefore an object of the present invention to provide a magnetic position device for using in a driver, which is capable of enhancing the sensitivity and the precision of the driver.

According to an aspect of the present invention, the magnetic position device for using in a driver includes a movable element having a first yoke assembly, and a fixed element adjacent to the movable element for generating a magnetic field to control the movable element to be moved toward a predetermined position.

Preferably, the fixed element includes a second yoke assembly, a magnet assembly connected to the second yoke assembly for generating the magnetic field, a first coil for generating a first motive force in a first direction in response to the magnetic flux of the magnetic field, and a second coil for generating a second motive force in a second direction in response to the magnetic flux of the magnetic field.

Preferably, the second coil is perpendicular to the first coil and the second direction is perpendicular to the first direction.

Preferably, the first coil and said second coil are winded around the second yoke assembly.

Preferably, the magnet assembly includes a plurality of permanent magnets.

Preferably, the movable element is capable of being moved along the first direction by the first motive force acted on the first yoke assembly.

Preferably, the movable element is capable of being moved along the second direction by the second motive force acted on the first yoke assembly.

The first coil is preferably a tracking coil and the second coil is preferably a focusing coil.

The first yoke assembly preferably includes two yokes being mounted on two opposite sides of the movable element, respectively.

Preferably, the driver is a read/write head of an optical read device

Preferably, the movable includes an optical lens.

According to another aspect of the present invention, the magnetic position device for using in a driver includes a movable element having a first yoke assembly, and a fixed element adjacent to the movable element for generating a magnetic field and having a coil assembly, wherein the coil assembly generates a motive force in response to the magnetic flux of the magnetic field to control the movable element to moved toward a predetermined position.

Preferably, the coil assembly includes a focusing coil and a tracking coil.

Preferably, the fixed element further includes a second yoke assembly and a magnet assembly connected with the second yoke to generate the magnetic field.

According to another aspect of the present invention, the position device is capable of controlling the position of an optical lens for using in a driver. The position device includes a movable element having a first yoke assembly, and a fixed element adjacent to the movable element for generating a magnetic field and having a coil assembly, wherein the coil assembly generates a motive force in response to the magnetic flux of the magnetic field, thereby controlling the optical lens to moved toward a predetermined position.

Preferably, the optical lens is mounted on the movable element.

The present invention may best be understood through the following descriptions with reference to the accompanying drawings, in which:

### BRIEF DESCRIPTION OF THE DRAWINGS

FIGS. 1 to 4 are schematic views showing position devices for using in a driver according to the prior art;

FIG. 5 is a schematic view showing a magnetic position device for being used in a driver according to a preferred embodiment of the present invention;

FIGS. 6 is a schematic view showing a magnetic position device by varying the focusing coils location in FIG. 5;

FIG. 7 is a schematic view showing a magnetic position device having a half of FIG. 5;

FIG. 8 is a schematic view showing a magnetic position device for changing the tracking direction and the focusing direction in FIG. 5;

FIG. 9 is a schematic view showing a magnetic position device having a half of FIG. 8;

FIGS. 10 to 12 are schematic views showing a magnetic position devices according to the modified preferred embodiments of the present invention; and

FIGS. 13 to 18 are schematic views showing other modified preferred embodiments of the magnetic position devices of the present invention.

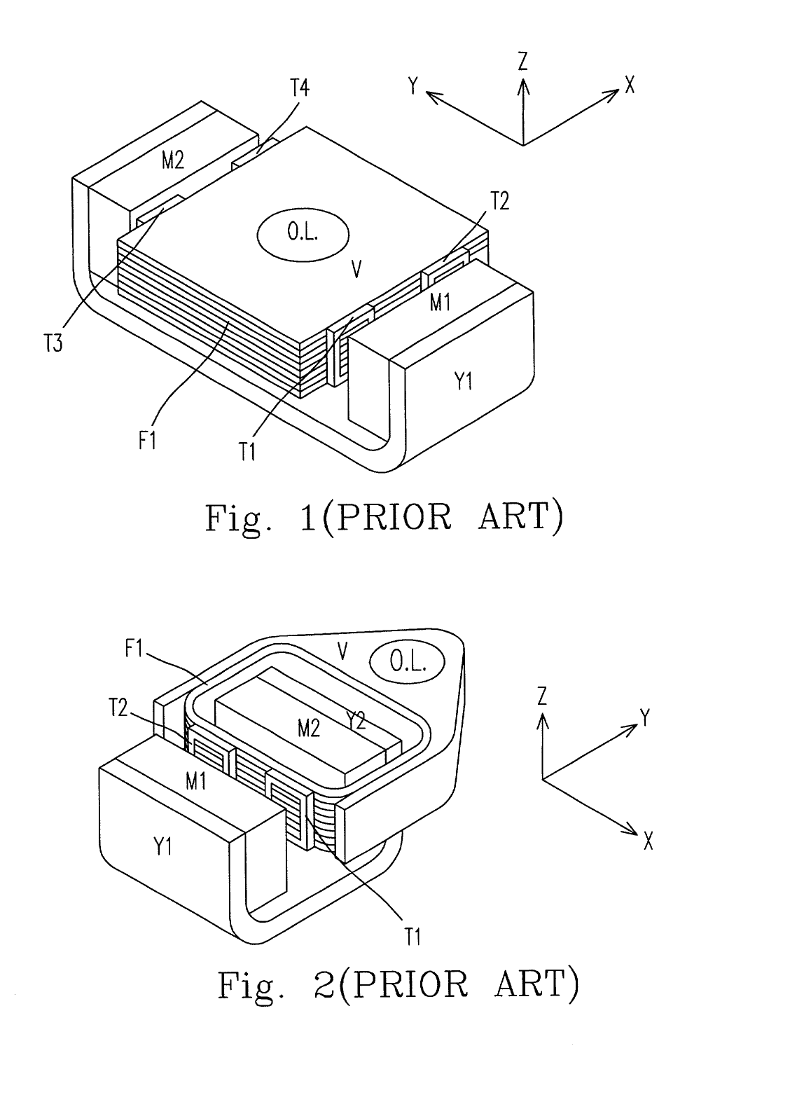

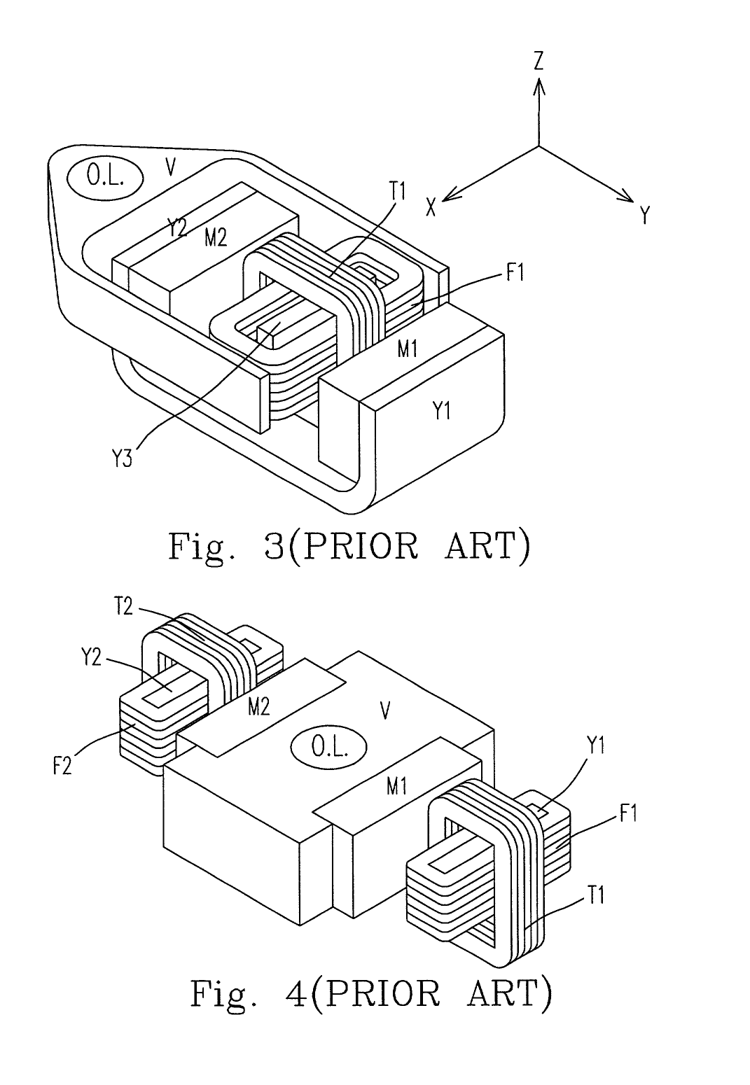

### DETAILED DESCRIPTION OF THE PREFERRED EMBODIMENTS

The present invention provides a magnetic position device for being used in a driver and enhances the efficiency and precision of the drivers for working position.

The operation principle of the present invention is similar to the prior art. The magnetic position device present invention is moving yokes type, which changes partial portions named Yoke 1 and Yoke 2 of the yokes to mount on the movable element V, yokes Y1 to Y4 and the permanent magnets M1 and M2 and the focusing coils F1 to F4, and the tracking coils T1 to T4 are mounted on the fixed element. The present invention has the advantages as follows.

(a) The weight of the movable element V would not be increased by adding the coils number or enlarging the magnets for enhancing the magnetic force; and

(b) The movable element V and the coils are produced separately, which is easy to be manufactured.

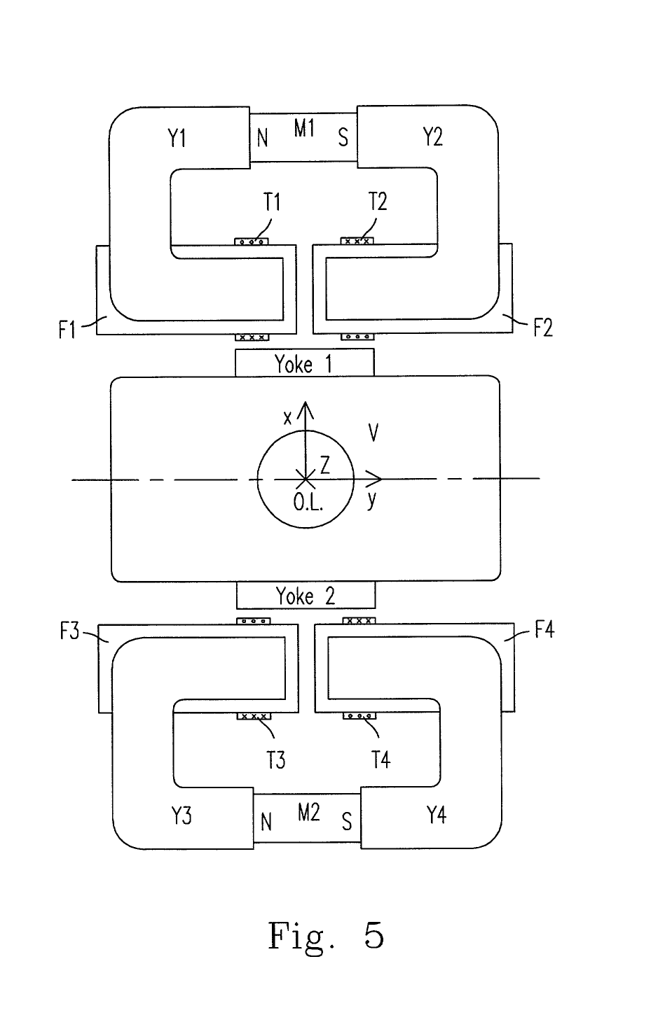

FIG. 5 shows the magnetic position device according the preferred embodiment of the present invention. A plurality of movable yokes (Yoke 1 and Yoke 2) are mounted on the movable element V. The magnetic field is generated by the permanent magnets M1 and M2 and the fixed yokes Y1 to Y4. The displacement and direction of the movable element V could be regulated by the magnetic force, e.g., Y-axis direction, generated by the tracking coils T1 to T4 in response to the magnetic flux of the magnetic field thereof and the magnetic force, e.g. Z-axis direction, generated by the focusing coils F1 to F4 in response to the magnetic flux of the magnetic field thereof. The focusing coils F1 to F4 are perpendicular to the tracking coils T1 to T4.

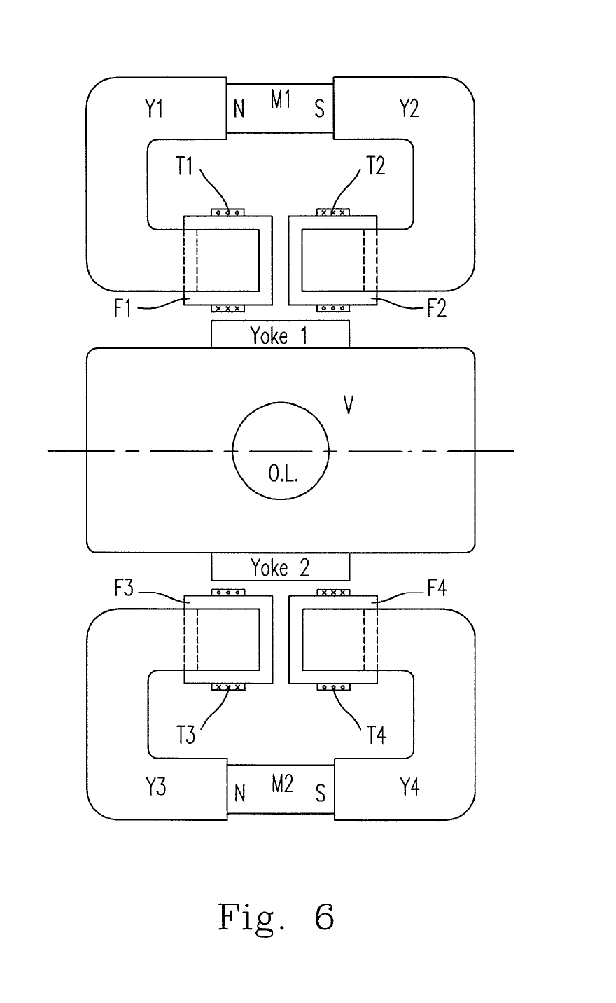

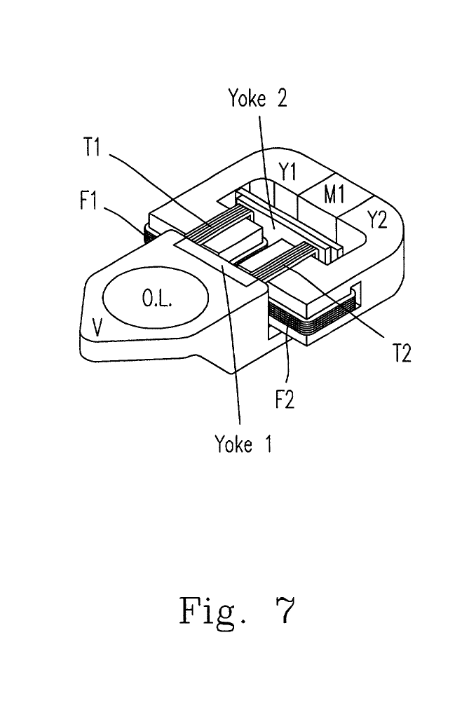

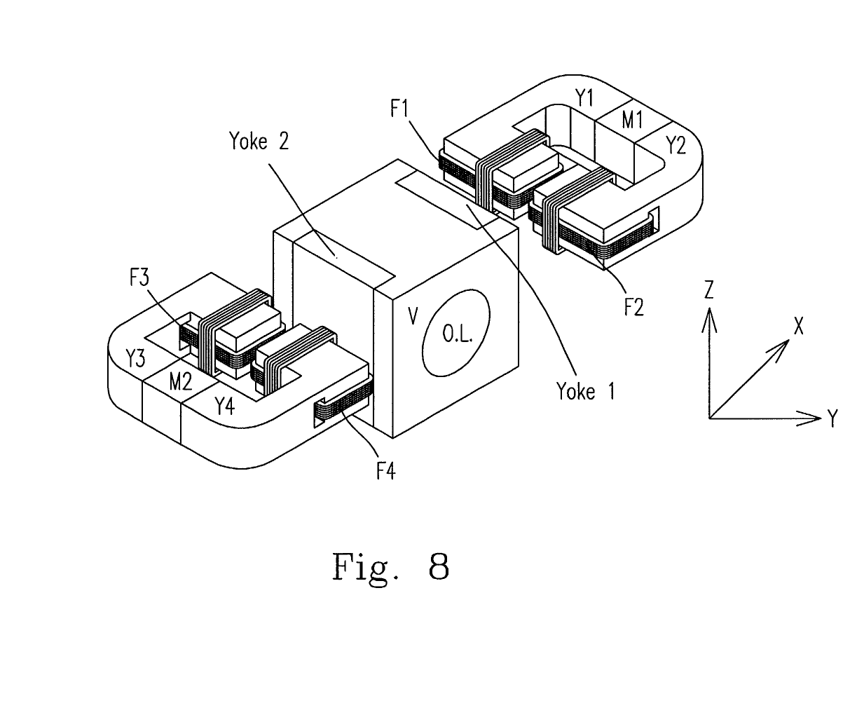

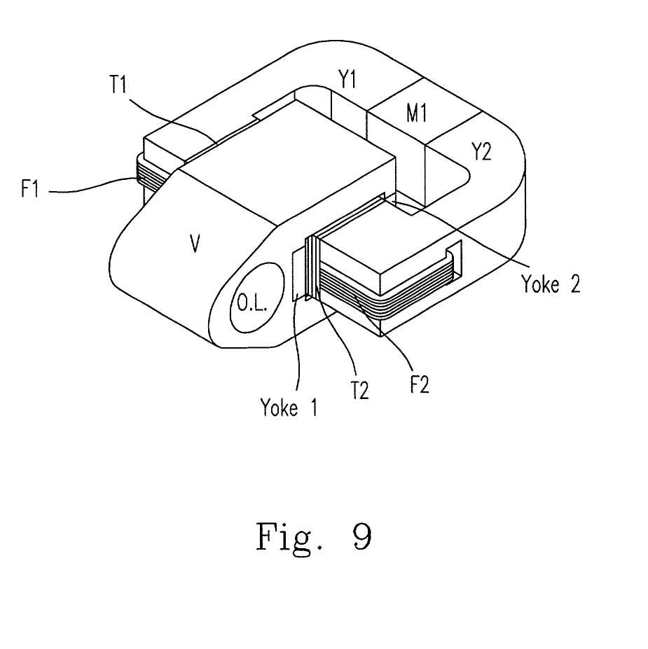

FIG. 6 shows a magnetic position device by varying the focusing coils location in to FIG. 5. FIG. 7 shows a magnetic position device having a half of FIG. 5. FIG. 8 shows the magnetic position device by varying the focusing direction in Y-axis and the tracking direction in Z-axis in to FIG. 5. Moreover, FIG. 9 shows the magnetic position device having a half of FIG. 8.

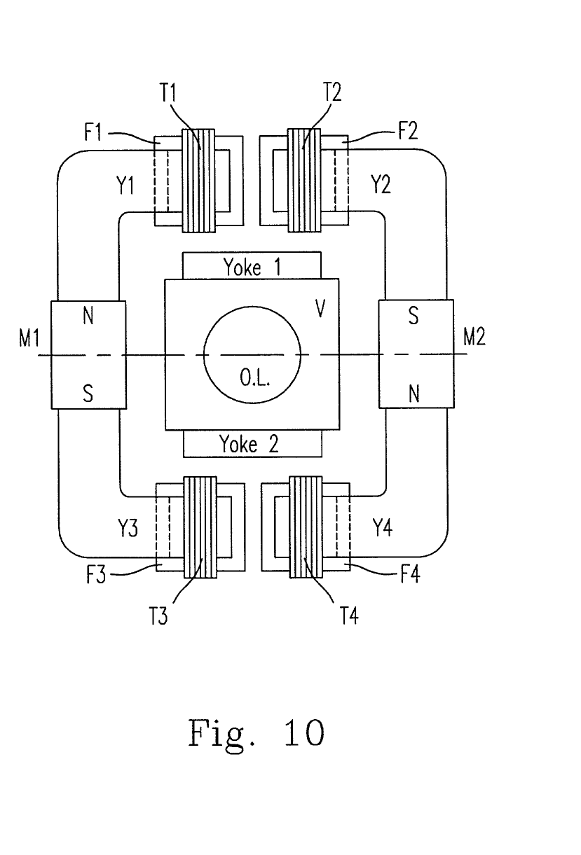

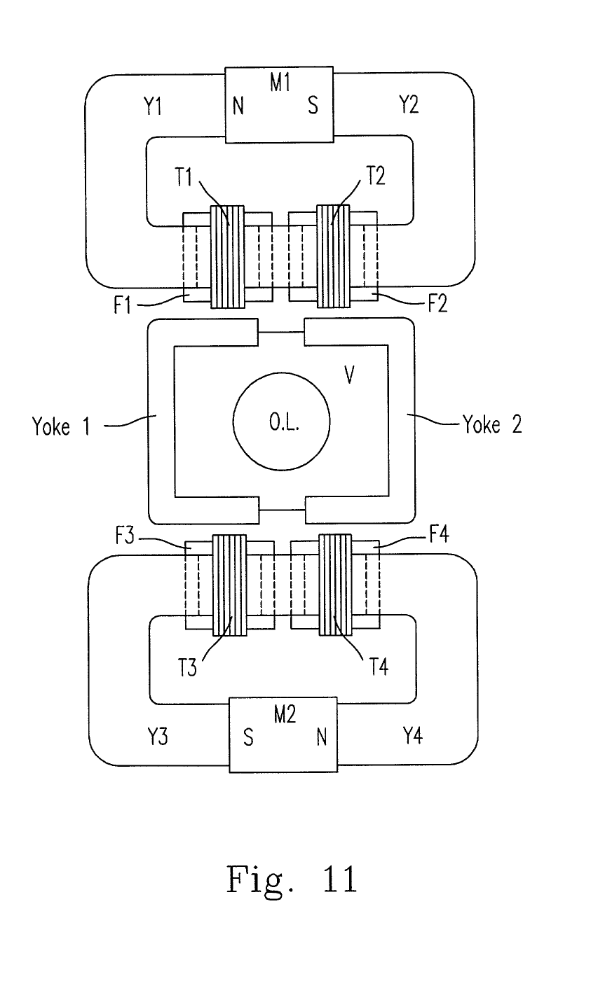

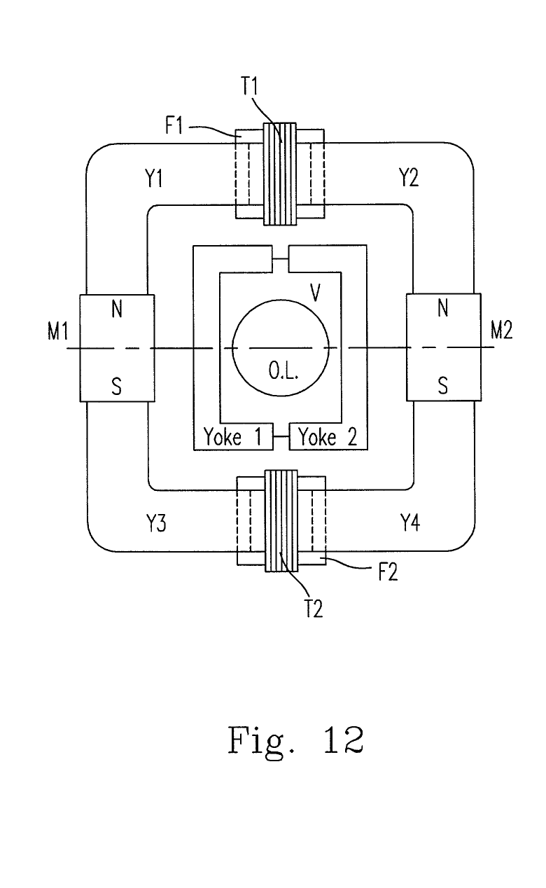

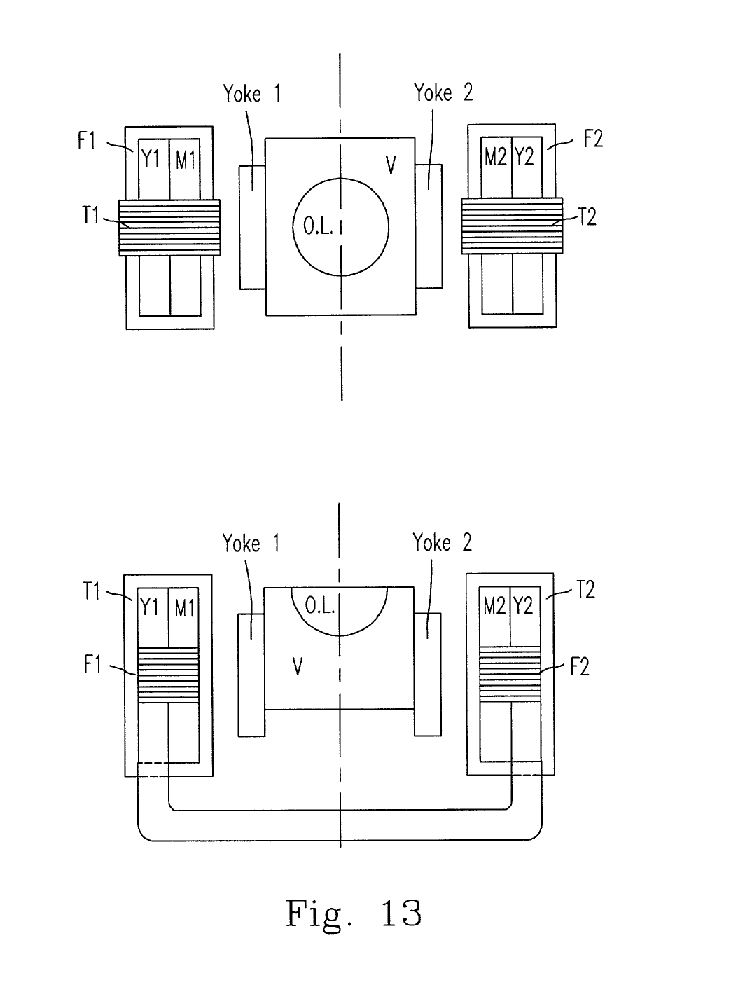

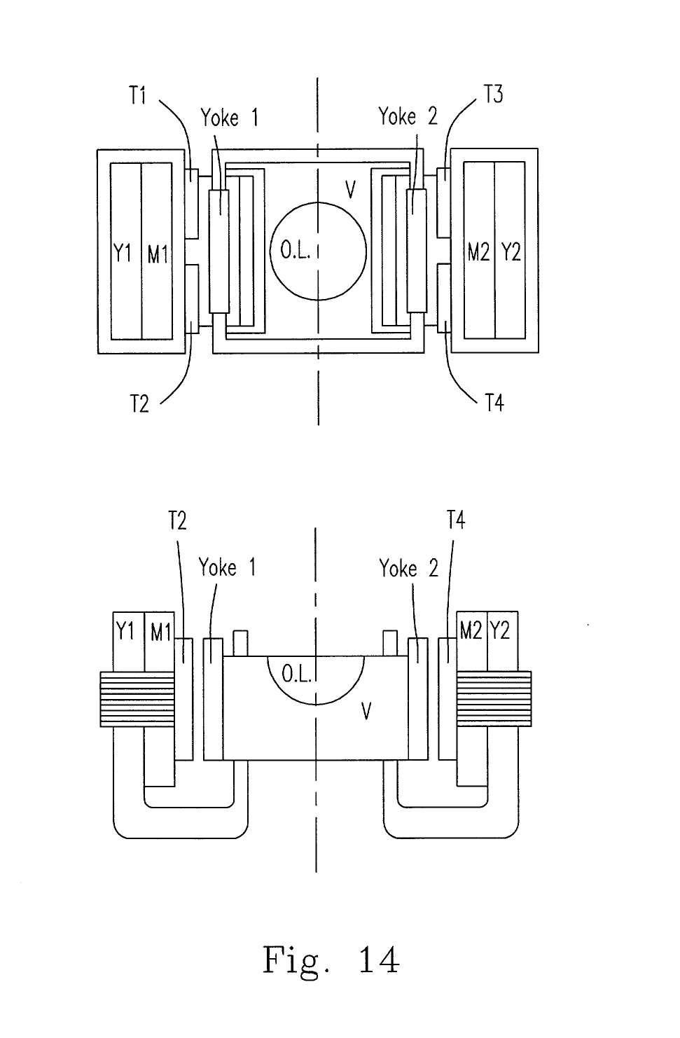

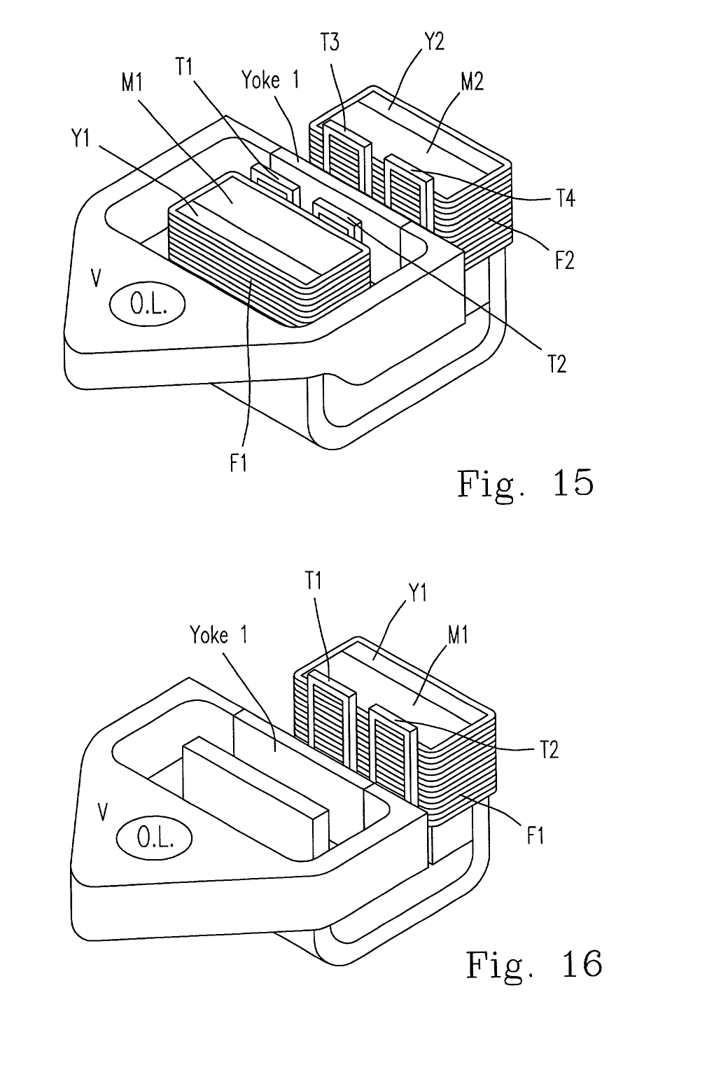

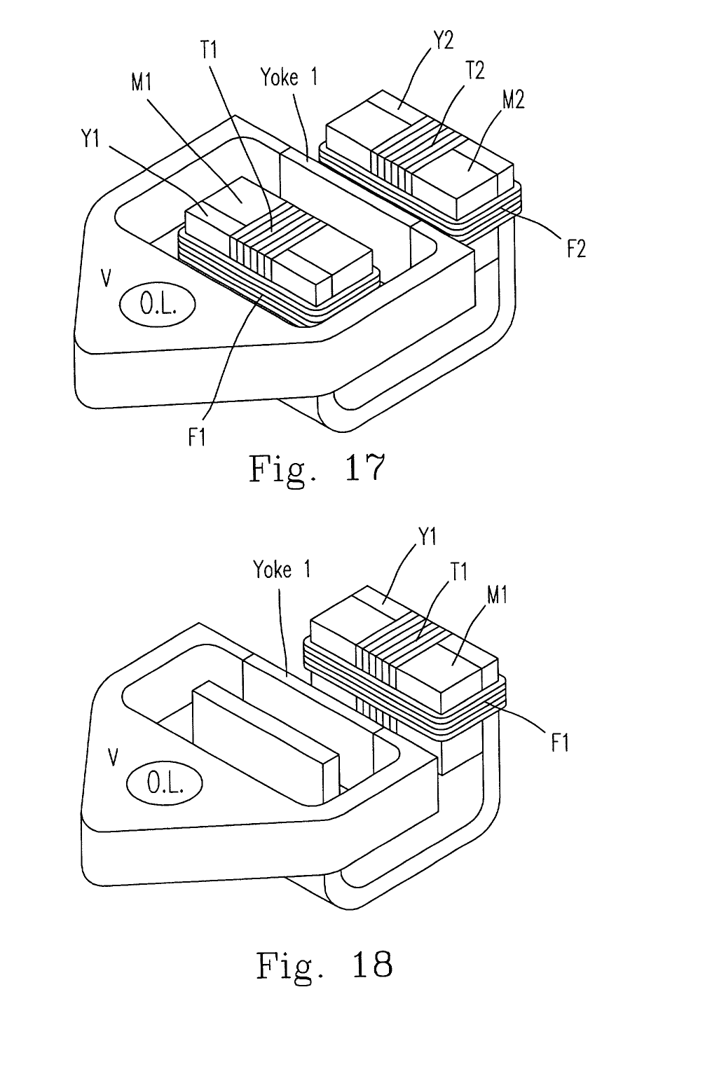

In addition, the magnetic position devices in accordance with FIGS. 10 to 12 are modified by varying the related location or the shape of yokes, magnets and coils. Furthermore, the operation principle is similar to the foregoing statements. The present invention further includes a half magnetic position device according to FIG. 7. The present invention also discloses the magnetic position device for varying the focusing direction in Y axis according to FIG. 8 and FIG. 9. FIGS. 13 to 18 show the magnetic position device to regular the location and the shape for yokes, magnets and coils according to the present invention. The operation principle is still similar to the above-mentioned description.

It is understood that the magnetic position device could flexibly be applied to different operation conditions. Moreover, the manufacturing cost will be decreased and manufacturing process is less time-consuming. Also, the reliability for the magnetic position device could be enhanced according to the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. A magnetic position device for using in a driver, comprising:
a movable element having a first yoke assembly; and
a fixed element adjacent to said movable element for generating a magnetic field to control said movable element to be moved toward a predetermined position.

2. The magnetic position device according to claim 1, wherein said fixed element comprises:
a second yoke assembly;
a magnet assembly connected to said second yoke assembly for generating said magnetic field;
a first coil for generating a first motive force in a first direction in response to the magnetic flux of said magnetic field; and
a second coil for generating a second motive force in a second direction in response to the magnetic flux of said magnetic field.

3. The magnetic position device according to claim 2, wherein said second coil is perpendicular to said first coil.

4. The magnetic position device according to claim 2, wherein said second direction is perpendicular to said first direction.

5. The magnetic position device according to claim 2, wherein said first coil and said second coil are winded around said second yoke assembly.

6. The magnetic position device according to claim 2, wherein said magnet assembly comprises a plurality of permanent magnets.

7. The magnetic position device according to claim 2, wherein said movable element is capable of being moved along said first direction by said first motive force acted on said first yoke assembly.

8. The magnetic position device according to claim 7, wherein said movable element is capable of being moved along said second direction by said second motive force acted on said first yoke assembly.

9. The magnetic position device according to claim 8, wherein said first coil is a tracking coil.

10. The magnetic position device according to claim 9, wherein said second coil is a focusing coil.

11. The magnetic position device according to claim 1, wherein said first yoke assembly comprises two yokes being mounted on two opposite sides of said movable element, respectively.

12. The magnetic position device according to claim 1, wherein said driver is a read/write head of an optical read device.

13. The magnetic position device according to claim 12, wherein said movable comprises an optical lens

14. A magnetic position device for using in a driver, comprising:
a movable element having a first yoke assembly; and
a fixed element adjacent to said movable element for generating a magnetic field and having a coil assembly, wherein said coil assembly generates a motive force in response to the magnetic flux of said magnetic field to control said movable element to moved toward a predetermined position.

15. The magnetic position device according to claim 14, wherein said coil assembly comprises a focusing coil and a tracking coil.

16. The magnetic position device according to claim 14, wherein said fixed element further comprises a second yoke assembly and a magnet assembly connected with said second yoke to generate said magnetic field.

17. A position device capable of controlling the position of an optical lens for using in a driver, comprising:
a movable element having a first yoke assembly; and
a fixed element adjacent to said movable element for generating a magnetic field and having a coil assembly, wherein said coil assembly generates a motive force in response to the magnetic flux of said magnetic field, thereby controlling said optical lens to moved toward a predetermined position.

18. The position device according to claim 17, wherein said optical lens is mounted in said movable element.
